(19) United States
(12) Patent Application Publication
(10) Pub. No.: US 2004/0111282 A1
(43) Pub. Date: Jun. 10, 2004

(54) Rental asset fee based on customer density

(76) Inventor: Stelios Haji-Ioannou, Monaco (MC)

Correspondence Address: OSTROLENK FABER GERB & SOFFEN, 1180 AVENUE OF THE AMERICAS, NEW YORK, NY, 100368403

(21) Appl. No.: 10/316,225

(22) Filed: Dec. 10, 2002

(51) Int. Cl. G06F 17/60; G06G 7/00

(52) U.S. Cl. 705/1; 705/400

(57) ABSTRACT

The rental price for a rentable asset, such as a car, at a rental facility is adjusted during the business day of the facility dependent upon customer density at particular times during the business day, with the rental price being higher at a time of higher customer density during the day and lower at a time of lower customer density during the day, with periodic readjustments to seek uniform density of customers throughout the business day of the facility.

### BACKGROUND OF THE INVENTION

Personnel in a premises, facility or agency which rents articles, for example cars, experience varying levels of customer traffic during a typical business day. The density of customers (customers per unit time) varies during the day. In a representative example of an automobile rental facility, the premises may be open 16 hours, from 7 a.m. to 11 p.m. Experience at the facility may have shown that there is a period of greater customer density early in the day e.g. 7-9:30 a.m., a quiet period e.g. 9:30-11:30 a.m., a midday greater density period of 11:30 a.m.-2 p.m., a quiet period after midday e.g. 2:30-5 p.m., a busy after workday period e.g. 5-7 p.m., and a quiet late period e.g. 7 p.m.-11 p.m.

A car rental facility has a premises at which cars available for rental are temporarily stored, an office where hopefully sufficient and not an excessive number of personnel are present to arrange rental transactions for renting cars to customers and for receiving returned rented cars or for receiving at least paperwork associated with the return, for inspecting, servicing and refueling and cleaning the car, if the facility performs all of those functions. All of the functions described require action by personnel. The operator of the rental facility would naturally prefer to have only the required number of personnel working, with not too few, which would cause impatience or ill will with customers, and not too many personnel, which would mean that some personnel are being underutilized and the operator of the facility is spending too much money on personnel costs. In order to enable the operator to higher or engage the optimum number of personnel, it is desirable for the customer density (number of customers per unit of time) to be as constant as possible during the business day. Customer demand typically varies during the day and the invention seeks to take account of these variations.

### SUMMARY OF THE INVENTION

The invention contemplates adjusting the rental price of the rented asset, such as a car, in order to encourage customers to make their rental transaction at the facility and take custody of the rentable asset at a time of lower customer density at the facility, by decreasing the rental price for the asset at times of lower customer density, even to charging a lower rental price to a customer who rents the asset at an earlier time than the customer might require to possess the asset.

By pricing asset rental dependent upon customer density, customers are encouraged to take possession of the asset, e.g. to enter into a rental agreement and take a rented car from a rental agency facility, during a period of lower customer density, e.g. at 3 p.m., rather than during a period of higher density, e.g. 6 p.m. The rental price is adjusted so that the daily rental rate or hourly rental rate for the asset or vehicle will be higher during a period of higher customer density and lower during a period of lower customer density. Under this method of pricing, if a rental car is picked up during a period of higher customer density and is returned to the facility after a shorter total rental time than if the car had been picked up at an earlier period of lower density, then even though the customer might have possessed the car for a shorter period of time, the rental price the customer would be charged might be higher, because of the higher customer density during the period when the car is picked up.

For the same reasons, although less important, the rental price might be adjusted depending upon the period when the customer returns the asset, assuming that the asset return requires dealing with agency or facility personnel, rather than merely a drop-off with accompanying paperwork and without having to deal directly with personnel. (The rental price might be adjusted dependent on whether the return requires dealing with personnel or not dealing with personnel).

The goal of the invention is to hold operating costs of the rental facility down by reducing the number of personnel required for performing entire rental transactions during the entire day. For a car rental facility, for example, personnel might be required to inspect and service a car before the rental, to complete a rental agreement with the customer, to deliver the car rented to the customer, to receive cars returned by customers and to handle possible paperwork associated with the return. It is a rare car rental facility employee who is willing to work only during short time period, spaced apart, high customer density intervals. Therefore, if the density of customers at a rental facility is evened out to some extent during the business day, it may be possible to reduce the number of personnel at the facility which are normally required to cover high density peak rental periods. The asset or car pickup times are spread out more uniformly or smoothed as customers learn how to save money on their car rentals by renting at low density periods, and the density of the customers and the density of customer transactions becomes somewhat more uniform.

### DESCRIPTION OF A PREFERRED EMBODIMENT

The present invention is applicable to any rentable asset which is rented from a rental facility where personnel are involved in the rental transaction and in the delivery of custody of the asset to the customer and also in the receiving the returned asset. The example below is a car rental agency and a single facility of the agency. However, the invention is applicable to a rental facility for any other asset and is applicable to multiple rental facilities or premises which are connected in a manner such that at least some of the same personnel may operate on behalf of each premises or facility of the agency.

According to the invention, a nominal rental rate for a period of time (weekday, weekend day, per half day, per hour) is assigned to each car available for rental based on an appropriate evaluation for that car model. Since the invention is intended to make the customer density at the particular facility more uniform than might otherwise be normally experienced during a business day, the method of the invention seeks to affect the customer density by adjusting the rental price for a particular model car over the course of a business day.

Based upon experience at the present facility or at like facilities, a determination is made as to the periods of time of greater and lesser density of customers. The normal car value based, preset price for the rental of the car is adjusted based on customer density. An algorithm is easily created based on customer density for adjusting the price. For example, starting with the nominal price for a car on a particular day of the week and for the particular period of time (month, week, several days, one day, half day or per hour) a factor related to customer density at the facility is applied to the nominal price to adjust the price in some proportion to the customer density at the time of rental. The factor selected will make the car more expensive for the entire rental period if it is rented and picked up during a period of higher customer density at the facility and less expensive if the car is rented and picked up at a time of lower customer density at the facility. The price variation is in a range precisely tied to the density, some proportionate mathematical adjustment based on density, or is a gross factor adjustment, e.g. only two values, one for high customer density and one for low density without fine adjustments for specific densities. The selected adjustment may be maintained for a period of time to be effective in influencing customer behavior as to rental times. It would be made known at the facility and elsewhere so that potential customers would be aware of the price to rent the same car at different times of the day. It is expected that at least some customers would be encouraged to rent a car at lower customer density times, with the result that customer density at the facility is made more uniform over the business day.

The actual customer density at the facility may be reassessed periodically so that the rental prices may be adjusted at the facility either by adjusting the times of day when different specific rates apply or the amount of the rate differential at different times of day, or both, depending upon operator selection and the algorithm selected for determining the rental price.

As rental of cars typically involves the preparation of a form rental agreement for the customer and the form rental agreement is generated at a computer terminal at the rental facility, the computer terminal can be programmed to store information concerning rental rates and as to the times when rental transactions are entered, both of which it stores now. The quantity of rental transactions for each selected unit of time during the business day is stored in the memory of the computers or the network of computer terminals of the facility. The determination of density can be based upon the stored information averaged over a selected period of time. This enables periodic adjustments to be made to the vehicle rental prices at the facility based upon customer density.

If customer density at a car rental facility becomes more uniform during a business day, the number of personnel required at the facility for each of the functions that has to be performed there may be adjusted, since the amount of work for performing all of the functions at the facility are dependent upon the number of cars rented by the facility in a period of time. The optimum number of personnel and therefore the optimum personnel costs can thereby be achieved.

As a further refinement of the present invention, generally, the only other time that a customer visits a car rental facility is when the customer returns the car at the end of the rental term. Just as there are times of higher density of rentals, there are also times of higher customer density of returns, which are likely to be concentrated either at the end of the business day or at the beginning of the business day for customer convenience and for customers who do not want to keep the rented car for an extra day. The information concerning the customer density at the time of return of the cars may also be stored, e.g. in the computer of the facility. The rental price for cars rented from the facility may be adjusted by taking into account the customer density at the time the cars are returned. Since customers may return the car and deliver the paperwork associated with the return to a storage container without having to deal directly with personnel, there is a reduced need for intervention by personnel in the return process, as contrasted with the previous rental process. But there is need for some personnel involved with the return of the car, e.g. those who take in the car and service it for rerental, and at least some personnel receive some paperwork associated with returns and possibly some maintain records concerning the returns. The returns of the rented cars is a lesser factor in the use of personnel. Some account may be taken in setting the rental price of the customer densities at the times of return. This may be entered as a factor in determining the car rental price throughout the business day. The factors of customer densities at rentals as contrasted with returns may be weighted so that the customer density at the rental has a greater influence on setting the rental price than the customer density at returns. All of the adjustments seek to make the customer density during the business day more uniform.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of establishing the rental price of a rentable asset rentable from a rental facility, comprising:
setting a nominal rental price for the asset, based at least on the value or cost of the asset to an entity including the rental facility renting the asset to a customer, the total duration of the rental arrangement, and the nature of the time period of the rental;
initially estimating the density comprising the number of customers per unit of time during selected periods of time during a business day when the facility is renting the assets to customers;
selecting and adjusting a price of rental of the asset during a business day, with respect to the nominal rental price, dependent upon the initial determination of customer density for renting of the asset at the facility, wherein the rental price for renting the asset is adjusted higher when an asset is rented at a time of greater customer density and is adjusted lower when the same asset is rented during a period of lower customer density during a business day at the facility.

2. The method of claim 1, further comprising periodically adjusting the rental price for the assets at the facility dependent upon customer density for having a lower rental price for periods of lower density at the facility and a higher rental price for periods of higher density at the facility.

3. The method of claim 2, further comprising storing information over a period of time as to the customer density during periods of a business day at the facility and using the stored information to adjust the rental price based on customer density.

4. The method of claim 1, further comprising determining the time at which the rented assets are returned to the rental facility, determining customer density at the times of return of the assets and adjusting the rental prices for the assets additionally based on the densities at the times of return of the assets to the facility, such that when the asset is returned at a time of lower density, the rental price for the asset is lower, and when the asset is returned at a time of higher customer density at the facility, the rental price for the asset is higher.

5. The method of claim 1, wherein the nature of the time period of the rental includes a workday, a non-workday, a work period and a non-work period.

6. The method of claim 1, wherein the rentable assets are cars.
